(19) United States
(12) Patent Application Publication
(10) Pub. No.: US 2009/0051987 A1
(43) Pub. Date: Feb. 26, 2009

(54) Method and arrangement for producing a hologram

(76) Inventors: Wolfgang Dultz, Frankfurt am Main (DE); Helmar Becker, Hanau (DE); Kay Michael Schmid, Frankfurt am Main (DE); Heidrun Schmitzer, Cincinnati, OH (US)

Correspondence Address: KENYON & KENYON LLP, ONE BROADWAY, NEW YORK, NY, 10004, US

(21) Appl. No.: 10/569,289

(22) PCT Filed: Jul. 22, 2004
(86) PCT No.: PCT/DE04/01632

§ 371 Date: Nov. 7, 2008

(30) Foreign Application Priority Data
Aug. 22, 2003 (DE) 10338556.8

(51) Int. Cl. G03H 1/02; G03H 1/04

(52) U.S. Cl. 359/3; 359/1; 359/34; 359/27

(57) ABSTRACT

A method and arrangement for producing a hologram of an object uses light, having photon packets, to illuminate the object and to serve as a reference light. Each photon packet includes a plurality of photons correlated in a quantum-mechanical manner and jointly form a multi-photon Fock state. Some of the photon packets may be used for illuminating the object, and some may be used as a reference light. Photon packets arriving from the object may be made to interfere with the reference light in an interference field, and the brightness distribution in the interference field or a part thereof may be registered by a detector. A light source emitting a plurality of mutually coherent rays of photon packets may be used for generating the packets, some of the rays being used for illuminating the object, and some of the rays being used as a reference light or for forming same.

### FIELD OF THE INVENTION

The present invention relates to a method and to an arrangement for producing a hologram.

### BACKGROUND INFORMATION

Holograms are diffractive structures, i.e., special diffraction gratings, which are arranged two-dimensionally or three-dimensionally and which reconstruct an object, upon illumination, as a stereoscopic image. To produce a hologram, coherent light, e.g., laser light, is typically split by a beam splitter into two component beams, the first of which is directed as an illuminating beam at an object, illuminating the same, and the second, i.e., a reference beam or reference light, is made to interfere in an interference field with the light, i.e., object light, coming from the object in response to illumination of the same by the illuminating beam. Thus, to produce the hologram, a two-beam interferometer is used, the amplitude and phase structure of the object being impressed on the light coming from the object, e.g., by the reflection or scattering at the object surface. When recorded by a video camera, the hologram is viewed directly, or it is transmitted to a video screen, such as a liquid crystal display.

The field of superposition of the two component beams, the interference field, is captured by a photoplate, or photographic plate, or by some other two-dimensionally resolving detector, thus producing the hologram. For example, video cameras can be used as the detector. And, the hologram produced by such cameras may be displayable on an LCD display.

To permit visual observation of the hologram, it is illuminated with light, which does not necessarily need to be coherent. Since the holograms contain complete spatial, or three-dimensional, information about the object surface, they can be used to produce three-dimensional documentation on the object. Contrary to ordinary photographs, holographically displayed images have considerable depth of focus. Holographically displayed images show the spatial structure of the object and allow a very rapid comparison to be made to a predefined pattern, e.g., using optical Fourier methods. Holograms can, therefore, be used for automatic object detection, as well as for monitoring and quality control processes in mass production.

One special application of holography is speckle pattern interferometry. It is suited for examining the shapes of highly stressed engineered components, such as automobile tires or turbine blades. See, for example, the reference entitled “Holography” by L. Huff, “Handbook of Optics”, vol. II, pages 23.1 et seq., New York, 1995.

As is true of interferometry in general, it holds for holography that the attainable spatial resolution is dependent on the wavelength of the light used. The resolution decreases in proportion to the wavelength of the light. Therefore, the resolution is doubled by halving the wavelength.

Another holographic application is fabricating masks used in photolithography to produce semiconductor components holographically. Techniques employed in modern photolithography use light having a wavelength of 240 nm. And, efforts are underway to use light having a wavelength of 200 nm. To improve resolution, complex technologies are being developed which aim to further reduce the wavelength of the light used. A lower bound is considered to be light having a wavelength of 150 nm, since, at shorter wavelengths, the substrates of the lithography masks are no longer transparent. However, to achieve a still higher resolution, it has been proposed to exploit the capability of certain optically nonlinear materials, to convert incoming light of wavelength λ into light of half wavelength λ/2, from two incoming photons of wavelength λ, one photon of wavelength λ/2 being formed in each case (“second harmonic model”). Producing one photon of half wavelength λ/2 from two photons of wavelength λ in this manner is known from the so-called two-photon microscopy (L. Moreaux et al. in Optics Letters 2000, vol. 25, p. 320). The disadvantages associated with this method are that only few materials are suited for producing the second harmonic mode, and very high pump laser power is required, which could possibly damage the object under investigation.

Various methods are known for producing photon packets, which are each composed of a plurality of mutually quantum-mechanically correlated photons which, together, produce a multiphoton Fock state. The photon packets can, in particular, be photon pairs, whose two members together produce a two-photon Fock state.

One method is based on nonlinear optics. A quantum optical effect is exploited that is based on optical parametric fluorescence. This process can be controlled in such a way that “multiphoton Fock states” form. To this end, photons from one laser, in the following termed primary photons, are radiated into a crystal suited for nonlinear optics. The crystal can be composed, for example, of beta-barium borate, of potassium-deuterium phosphate or of lithium niobate. When passing through the crystal, the primary photon is converted with a certain probability by optical parametric fluorescence into a pair of two secondary “entangled” photons, whose total energy corresponds to the energy of the primary photon. The wavelength of each secondary photon is, therefore, greater than that of the primary photon.

Thus, in contrast to the two-photon microscopy mentioned above, one radiated photon of a smaller wavelength is not produced from two radiated photons, rather, two radiated photons, each of a larger wavelength, are produced from one radiated photon.

The technical literature describes the secondary photon having the greater energy as “signal photon” and that having less energy as “idler photon.” See, e.g., reference “Quantenphänomene in der Welt des Lichtes” [i.e., “Quantum Phenomena in the World of Light”], by J. Brendel, Physics Series, vol. 28, pages 41 et seq. The photon packets can be easily fed into optical waveguides using available methods.

Another method for producing photon pairs provides for using a two-photon laser as a light source. A two-photon laser is described, for example, in the reference “Polarization Instabilities in a Two-Photon Laser,” by O. Pfister et al., Physical Review Letters, vol. 86, no. 20, May 2001, pages 4512-4515.

### SUMMARY OF THE INVENTION

The present invention provides an arrangement and a method for producing holograms having an increased resolution.

The present invention provides a method for producing a hologram of an object, in which photon packets are used to illuminate the object and as reference light, each of the photon packets is composed of a plurality of mutually quantum-mechanically correlated photons which, together, produce a multi-photon Fock state,

one portion of the photon packets being used for illuminating the object and one portion of the photon packets being used as reference light;

photon packets coming from the object being made to interfere with the reference light in an interference field;

and the brightness distribution in the interference field or in a part of the same being recorded by a detector.

The present invention provides an arrangement for producing a hologram of an object, including a light source capable of emitting photon packets, each of which is composed of a plurality of mutually quantum-mechanically correlated photons which, together, produce a multi-photon Fock state,

one portion of the photon packets emitted by the light source being able to illuminate the object and one portion of these photon packets being able to function as reference light;

photon packets coming from the object being made to interfere with the reference light in an interference field;

and the brightness distribution in the interference field or in a part of the same being recordable by a detector.

The photon packets coming from the object are those packets that were used to illuminate the object, and, for example, were reflected, scattered, diffracted or refracted by the object and, therefore, emanate from the object as object light. This means that the object light emanates from the object due to illumination of the object by photon packets. When the reference light composed of photon packets interferes with photon packets coming from the object, a brightness distribution, namely an interference pattern, is formed in the interference field and is recorded by the detector as a hologram.

The members of such photon packets behave spectroscopically and, with respect to their transmission properties, in accordance with their respective wavelengths. Interferometrically the behavior of one such photon packet is analogous to one photon whose energy is equal to the total energy of all individual photons of the photon packet. Therefore, when holograms are produced using such photon packets, one may achieve a resolution substantially higher than that that which would be obtained using conventional light of the same wavelength as the packet photons.

The present invention may be employed in photolithography, for example, to fabricate semiconductor components. When photon packets are used, for example, which are each composed of two photons of 200 nm wavelength, a resolution comparable to a 100 nm wavelength may be achieved, without any decrease in the transparency, or light transmittance, of the substrates of the lithography masks in comparison to the use of conventional light of 200 nm wavelength.

The present invention may also provide producing a hologram requiring that the light for illuminating the object and/or the reference light be transmitted through light guides. In this case, the present invention permits use of such light that is still transmitted by the light guides at low loss, while making one able to achieve a resolution comparable to a substantially shorter wavelength that is no longer transmitted by the light guides or is only still transmitted at high loss.

The present invention provides for any given objects to be measured holographically, for example, using light of a wavelength λ, as if—in the case that the photon packets are photon pairs, for example—light of half of the wavelength, i.e., of wavelength λ/2, were used, i.e., at twice the resolution. This may be accomplished using quantum-mechanically correlated photon pairs, which behave in the same way as single photons of half wavelength λ/2.

The resolution may be further increased correspondingly by using the photon packets, which each include more than two photons, in accordance with the present invention. The increase in the resolution generally reaches a factor N, N being the number of correlated photons per photon packets.

Photon packets, which originate from the same light source, may be used to illuminate the object, and as reference light. To generate the photon packets, a light source may be used that is capable of emitting a coherent beam of such photon packets. For that reason, in a further arrangement according to the present invention, the light source is capable of emitting a coherent beam of such photon packets.

Alternatively, a light source that is capable of emitting a plurality of mutually coherent beams of such photon packets may be used to produce the photon packets. An embodiment of the present invention provides that the light source be capable of emitting a plurality of mutually coherent beams of such photon packets. In this case, each photon packet, for example, a photon pair, is generated in one of a plurality of channels, it not being predictable in which one.

At least one of the beams of photon packets may be used for illuminating the object and at least one other of the beams of photon packets as reference light or to produce the same. An embodiment of the present invention provides for at least one of the beams of photon packets to be capable of illuminating the object and at least one other of the beams of photon packets to be capable of functioning as reference light or of producing the same. For example, the reference light may be produced by widening that beam or those beams of photon packets capable of functioning as reference light or of producing the reference light.

The light source used may be one which, as photon packets, produces photon pairs whose two members are mutually quantum-mechanically correlated and, together, are in a two-photon Fock state. In this case, photon pairs are used as photon packets. Thus, the light source may be one which, as photon packets, produces photon pairs whose two members are mutually quantum-mechanically correlated and, together, are in a two-photon Fock state.

The light source used may be one in which the photon packets are generated in that primary photons of mean wavelength λ are radiated from a primary light source, e.g., a laser, into an optically nonlinear crystal, which is so constituted and oriented that the photon packets are formed in the optically nonlinear crystal from primary photons radiated into the same, as the result of optical parametric fluorescence. In a further embodiment, the light source has a primary light source, e.g., a laser, and an optically nonlinear crystal, the primary light source radiating primary photons of mean wavelength λ into the crystal which is so constituted and oriented that it produces photon packets from the primary photons radiated into the same, as the result of optical parametric fluorescence.

The energy distribution between the signal photon and the idler photon of the photon pair is not always the same, but statistically distributed and given by a probability distribution. The secondary photons may possess the same energy, which means that each of the two has half of the wavelength of the primary photon. Using an interposed monochromator, those photons whose wavelength deviates by more than a specific amount from half of the wavelength of the primary photon, may be filtered out, so that only those photon pairs are able to pass through, whose two members have approximately the same wavelength.

Another embodiment of the present invention provides for a light source to be used which has the following components:

a) a primary light source, e.g., a laser, which emits a beam of primary photons of mean wavelength λ;

b) an optically nonlinear crystal, which is constituted, arranged, and oriented, so that at least one portion of the primary photons is incident to the crystal and, as the result of optical parametric fluorescence, generates in the same one pair each of secondary photons emerging from the crystal, i.e., one signal photon and one idler photon belonging to and quantum-mechanically correlated with the signal photon;

c) an interferometer having two arms, between which an optical path-length difference exists that is both smaller than the coherence length of the signal photon, as well as smaller than the coherence length of the idler photon, at least one portion of the pairs of secondary photons being incident to the interferometer in such a way that, in each instance, the signal photon propagates through the first arm and the associated idler photon through the second arm;

d) a beam coupler having a first and a second coupler output,

the signal photons and the associated idler photons may be able to enter the beam coupler at incidence after propagating through the interferometer;

the signal photon of each pair of secondary photons which entered the beam coupler at incidence being able to interfere with its associated idler photon in the beam coupler;

following this interference, each signal photon and each idler photon being able to exit the beam coupler both through the first and through the second coupler output;

so that the signal photon and its associated idler photon are able to exit the beam coupler;

either separately from one another through different coupler outputs;

or, together, as a photon pair whose members are mutually quantum-mechanically correlated and, together, are in a two-photon Fock state, through each of the two coupler outputs; and, thus, a first beam of such photon pairs exits through the first coupler output, and a second beam of such photon pairs exits through the second coupler output, two beams of such photon pairs being thereby produced.

In another embodiment, the light source which may be used in embodiments of the present invention include:

a) a primary light source, e.g., a laser, which emits a beam of primary photons of mean wavelength λ;

b) an optically nonlinear crystal, which is so constituted and arranged that at least one portion of the primary photons enters the crystal at incidence and, as the result of optical parametric fluorescence, generates in the same one pair each of secondary photons emerging from the crystal, namely, one signal photon and one idler photon belonging to and quantum-mechanically correlated with the signal photon;

c) an interferometer having two arms between which an optical path-length difference exists that is both smaller than the coherence length of the signal photon, as well as smaller than the coherence length of the idler photon, at least one portion of the pairs of secondary photons entering the interferometer at incidence in such a way that the signal photon propagates through the first arm and the associated idler photon through the second arm;

d) a beam coupler having a first and a second coupler output,

the signal photons and the associated idler photons may be able to enter the beam coupler at incidence after propagating through the interferometer;

the signal photon of each pair of secondary photons which entered the beam coupler at incidence being able to interfere with its associated idler photon in the beam coupler;

following this interference, each signal photon and each idler photon being able to exit the beam coupler both through the first and through the second coupler output;

so that the signal photon and its associated idler photon are able to exit the beam coupler

either separately from one another through different coupler outputs;

or, together, as a photon pair whose members are mutually quantum-mechanically correlated and, together, are in a two-photon Fock state, through each of the two coupler outputs; and, thus, the light source is capable of emitting a first beam through the first coupler output and a second beam of such photon pairs through the second coupler output.

These beams may be used to directly illuminate a very small object, for example, or as reference light, or they may be widened to illuminate the object or to form the reference light.

The two arms of the interferometer merge in the beam coupler. The optical parametric fluorescence process employed here may be controlled in such a way that the two photons of one photon pair emerge from the crystal in different directions, enabling the first photon of each pair to be coupled into the first arm and the second photon into the second arm of the interferometer, while entailing only little outlay for equipment. The primary light source may, e.g., be a laser, also described here as a “pump laser”, as well as a continuous laser or a pulse laser.

The photons of a photon pair produced in this manner are mutually correlated and entangled in many different ways. The corresponding light paths, i.e., the associated interferometer arms, are often termed signal arm and idler arm. When these kinds of photon pair sources are used, the coherence length of the first and second photon, respectively, may typically be 10 . . . 500 μm; the wavelength of the first and second photon, respectively, may be 1.3 μm, for example.

As a beam coupler, a beam splitter, such as a beamsplitter plate may be used, in particular. In addition, the beam coupler may be a polarizing beam splitter or a fused coupler. The beam coupler may be set up in such a way that no coupler output is preferred over another coupler output.

As an optically nonlinear crystal, one may be used, for example, that is composed of beta-barium borate, of potassium-deuterium phosphate or of lithium niobate.

Considered quantum-mechanically, no photon pair whose members are mutually quantum-mechanically correlated and, together, are in a two-photon Fock state, exits the beam coupler in the classical sense only through the first or only through the second coupler output. Rather, the photon pairs are entangled in both coupler outputs, i.e., both members of each photon pair of this type exit the beam coupler together, both through the first and, at the same time, also through the second coupler output. This is due to the wave character of the particles involved. However, the photon pair is, of course, only detectable in one of the two coupler outputs. If it is detected in the first coupler output, then it is no longer detectable in the second coupler output, and vice versa.

The first beam of photon pairs may be used for illuminating the object and the second beam of photon pairs as reference light or for forming the same, or vice versa.

In another embodiment of the present invention, the first beam of photon pairs is capable of illuminating the object, and the second beam of photon pairs is capable of functioning as reference light or of forming the same, or vice versa. Thus, the need is eliminated here for the beam splitter, which, under the available art, typically splits the coherent light required for producing a hologram into the illuminating beam and the reference beam or the reference light, since, in accordance with this embodiment of the present invention, the light source already emits two coherent component beams in the first place, of which one is able to be used to illuminate the object and the other as a reference beam or, for example, to form the same by widening.

In a further embodiment of the present invention, an adjustable delay path may be optically interposed in at least one of the interferometer arms, making it possible for a specific optical path-length difference D to be selected between the interferometer arms. Probability W that the signal photon and the idler photon interfere in the beam coupler in such a way that they do not exit the beam coupler separately from one another through different coupler outputs, but rather, together, through the same coupler output, is largely dependent on optical path-length difference D, i.e., the level of efficiency achieved in generating the photon pairs may be optimized by choosing the right path-length difference.

This dependency of mentioned probability W on optical path-length difference D is relatively complicated. If one plots probability W over optical path-length difference as curve W(D), then this curve shows a steady characteristic including a few minima and maxima, i.e., of extreme values. As a result of the photon-pair interference, a so-called fourth-order interference pattern, also termed “Hong-Ou-Mandel interference”, is obtained. The signal photon and its associated idler photon possess the ability to interfere, in pairs, in such a fourth-order interference. In this case, given vanishing path-length difference D, i.e., for value D=O, a principal maximum exists, in which probability W reaches a theoretical value of 100%. In practice, a value of over 95% is easily reached for probability W.

Therefore, the amount of optical path-length difference D existing between the first and the second arm of the interferometer is preferably selected to be less than 5λ, λ being the mean wavelength of the primary photons.

Thus, in a further embodiment, the arrangement is set up in such a way that the amount of optical path-length difference D existing between the first and the second arm of the interferometer is less than 5λ, λ being the mean wavelength of the primary photons.

In a further embodiment, the level of efficiency achieved in generating the photon pairs is optimized in that optical path-length difference D existing between the first and the second arm of the interferometer is selected in such a way that the ratio of the number of instances when the signal photon and its associated idler photon exit together through the same coupler output, to the number of instances when the signal photon and its associated idler photon exit the beam coupler separately from one another, through different coupler outputs, reaches a time-averaged maximum.

Thus, in a further embodiment, optical path-length difference D existing between the first and the second arm of the interferometer is selected in such a way that the ratio of the number of instances when the signal photon and its associated idler photon exit together through the same coupler output, to the number of instances when the signal photon and its associated idler photon exit the beam coupler separately from one another, through different coupler outputs, exhibits a time-averaged maximum.

If, instead of the photon pairs, photon packets each having n members are used, then instead of the 4th order interference, a 2n order interference is obtained.

A beam or beams of photon pairs may also be produced in a different manner. In accordance with one variant, a light source is used in which the photon pairs are produced by quadrupole transitions or cascade transitions occurring in the light source. Another variant provides for a light source to be used in which the photon pairs are produced by a two-photon laser. Yet another variant provides for a light source to be used in which the photon pairs are produced by a Coulomb blockade effect occurring in the light source.

The beam of photon packets may be split into a plurality of mutually coherent photon-packet component beams, or a plurality of mutually coherent photon-packet component beams may be extracted from the beam of photon packets, at least one of the photon-packet component beams being used for illuminating the object and at least one other of the photon-packet component beams being used as reference light or for forming the same. In this connection, a greater number of photon-packet component beams may be used to illuminate the object than to produce the reference light, for example, in order to compensate for reflection losses of the illuminating beam at the object, and, in the area of the interference field, in order that the intensity of the light coming from the object, i.e., an object beam, be as similar as possible to the intensity of the reference light.

A light source also may be used which generates a plurality of beams of photon packets, in that primary photons of mean wavelength λ are radiated from a primary light source, e.g., a laser, into a plurality of optically nonlinear crystals, the crystals being so constituted, arranged and oriented that, in each of the crystals, one of the beams of photon packets is formed from radiated primary photons as the result of optical parametric fluorescence. When light sources of this kind are used, there is no need to split the beam of photon packets into component beams, since a plurality of beams of photon packets is already produced in the first place. One embodiment of the present invention provides for the light source to have a primary light source, e.g., a laser, as well as a plurality of optically nonlinear crystals, the primary light source radiating primary photons of mean wavelength λ into each of the crystals, and the crystals being so constituted and oriented that, in each of the crystals, one of the beams of photon packets is formed from radiated primary photons as the result of optical parametric fluorescence.

Thus, each photon packet, for example, a photon pair, is generated in one of a plurality of channels, it not being predictable in which one.

Another embodiment of the present invention provides that the number of photon-packet component beams or of beams of photon packets used to illuminate the object be greater than the number of photon-packet component beams or of beams of photon packets used as reference light, for example, in order that the intensity of the light coming from the object be as similar as possible to that of the reference light.

In a further embodiment, the optically nonlinear crystal or the optically nonlinear crystals are composed of beta-barium borate, potassium-deuterium phosphate, or lithium niobate.

In a further embodiment, the optically nonlinear crystal or the optically nonlinear crystals are designed as optical waveguides.

In this connection, a primary light source may be used which emits a beam of primary photons of mean wavelength λ, the beam of primary photons being split into a plurality of mutually coherent component beams of primary photons, or a plurality of mutually coherent component beams of primary photons being extracted from the beam of primary photons, and each of the thus produced component beams of primary photons being radiated into one of the optically nonlinear crystals. Thus, in this case, the beam of primary photons is already split into component beams.

From the beam of photon packets or the beam of primary photons, it is possible to extract a plurality of photon-packet component beams or a plurality of component beams of primary photons in different ways. One embodiment provides for the beam of photon packets or the beam of primary photons to be split by at least one obstacle introduced into the same or by a diaphragm, or a stop, having a plurality of pinholes or by at least one beam splitter introduced into the same, into a plurality of photon-packet component beams or a plurality of component beams of primary photons.

Another embodiment provides for the beam of photon packets or the beam of primary photons to be split by a phase plate introduced into the same, into a plurality of at least partially mutually phase-shifted, photon-packet component beams or component beams of primary photons.

In this connection, an embodiment provides for a phase plate to be used which splits the beam of photon packets into two photon-packet component beams, between which a phase difference of (2n+1)*π/Z exists, n being a whole number and Z the number of photons per photon packet.

In a further embodiment, a zone plate having a first and a second zone group is used as a phase plate. Its design is such that a photon-packet component beam emanates from every zone of the first zone group, so that, emanating from the zone plate is a first group of photon-packet component beams whose characteristic is such that every photon-packet component beam of this first group has propagated through one of the zones of the first zone group; and emanating from every zone of the second zone group is a photon-packet component beam, so that, emanating from the zone plate is a second group of photon-packet component beams whose characteristic is such that every photon-packet component beam of this second group has propagated through a zone of the second zone group. The photon-packet component beams of the first group exhibit a phase difference of (2m+1)*π/Z compared to those of the second group, m being a whole number and Z the number of secondary photons per photon packet.

The phase difference produces interference directly downstream of the phase plate in the boundary region between the photon-packet component beams, which diminishes the light intensity in the boundary region, the total intensity of the component beams not diminishing since no photons are extracted from the component beams. When the phase difference is selected in such a way that the photon-packet component beams are in phase opposition, the intensity in the boundary region is equal to zero.

In another embodiment, to extract a plurality of photon-packet component beams from the beam of photon packets, or to extract a plurality of component beams of primary photons from the beam of primary photons, one optical waveguide is used in each case, which is introduced into the beam of photon packets in such a way that a portion of the beam of photon packets and, respectively, a portion of the beam of primary photons are coupled into each optical waveguide.

In addition, as a primary light source, one may be used which emits a plurality of beams of photon packets, each of mean wavelength λ, each of which is radiated into one of the optically nonlinear crystals in such a way that, in each of the crystals, one of the beams of photon packets is formed from one of the beams of primary photons radiated into the same, as the result of optical parametric fluorescence.

Therefore, in a further embodiment, the primary light source is capable of emitting a plurality of beams of primary photons, each of mean wavelength λ, and of radiating them into one each of the optically nonlinear crystals in such a way that, in each of the crystals, one of the beams of photon packets is formed from the beams of primary photons radiated into the same, as the result of optical parametric fluorescence.

Primary light sources may be used which emit two or more coherent beams of primary photons in the first place, obviating the need for any splitting into component beams or for extracting component beams.

Therefore, as a primary light source, an embodiment provides for using a laser in which a transverse mode or a spiral mode is generated, which leads to the formation of at least two discrete brightness zones in the laser, each one of which emits one of the beams of primary photons. Another embodiment provides for using a kaleidoscope laser as a primary light source, in which a plurality of discrete brightness zones form, each one of which emits one of the beams of primary photons.

A further embodiment provides for using at least two of the beams of photon packets to illuminate the object and, prior to reaching the same, for the beams to be widened into illuminating beams in such a way that each illuminating beam completely covers the object.

A further embodiment provides for using at least two of the beams of photon packets to illuminate the object and, prior to reaching the same, for the beams to be widened into illuminating beams in such a way that each illuminating beam only covers a portion of the object, and all illuminating beams, together, cover the entire object. The widening may be accomplished, for example, by an appropriate number of lenses or by an areal array of lenses, preferably, but not necessarily designed as diverging lenses, or by diffraction gratings.

A further embodiment of the present invention provides for a light source to be used to generate the photon packets that is set up in such a way that the object light and the reference light have the same amplitude, i.e., the same intensity in the interference field.

A further embodiment provides for at least two of the beams of photon packets to be used to produce the reference light in that, reaching the detector, they are each widened into reference beams in such a way that the reference beams all overlap in a region that takes up at least 90% of the interference field.

A further embodiment provides for at least two of the beams of photon packets to be used to produce the reference light in that, before reaching the detector, they are each widened into reference beams in such a way that each of the reference beams overlap with one or more of the other reference beams in a region that takes up, at most, 10% of the interference field.

To record the interference field, a two-dimensionally resolving detector is used, which may be a video camera with or without a lens. In addition, the detector may be a photoplate, for example. Moreover, a detector may be used, for example, which includes a two-dimensional array of a plurality of light-sensitive sensor elements, which may be CCD elements.

In a further embodiment, the use of a two-dimensionally resolving detector is not essential. A further embodiment provides for a detector to be used which includes a light-sensitive sensor element capable of scanning the interference field. The sensor element may be a CCD element, for example, or be composed of a plurality of such elements disposed in a fixed array. At no time is such a detector spatially resolving. Spatial resolution is first achieved by the scanning process.

A further embodiment provides for a detector to be used which includes two light-sensitive sensor elements capable of scanning the interference field dependently or independently of one another; in this case as well, a two-dimensional image is first created by the scan process.

A further embodiment provides for a detector to be used which includes the following components:

a) a detector beamsplitter which is oriented to permit the photons coming from the object and photons of the reference beam to impinge thereon and is capable of transmitting a portion of these photons and of deflecting another portion of these photons;

b) a first light-sensitive sensor element, which is oriented to permit only those photons transmitted by the detector beamsplitter, to enter into the same at incidence;

c) as well as a second light-sensitive sensor element, which is oriented to permit only those photons deflected by the detector beamsplitter, to enter into the same at incidence;

and is capable of scanning the interference field.

Thus, this detector does not possess any intrinsic spatial resolution, or capability, either. Spatial resolution is likewise first achieved by the scanning process.

To suppress background noise which would degrade the contrast of the hologram, a detector may be used which is only responsive to one of the photon packets entering the detector at incidence, and not to one single photon entering the same at incidence, alone.

A further embodiment provides for a detector to be used which is capable of functioning in response to individual photons entering the detector at incidence.

A further embodiment provides for a detector to be used which only functions in response to two photons, whose energy is greater in each instance than a specified low threshold value, entering the detector at incidence within a specifiable time span window. In this manner, photons which originate from background thermal radiation or ambient light, for example, may be reliably suppressed.

In this connection, a detector also may be used which is only responsive, for example, to the energy of both photons being less in each instance than a specified first upper threshold value. This allows for suppression of the photon packets produced by optical parametric fluorescence, such as primary photons which reach the detector spuriously, since the energy of each photon packet produced by optical parametric fluorescence is less than that of the primary photons.

In a further embodiment, a detector may also be used which is only responsive when, in addition, the total energy of both photons is less than a specified, second upper threshold value. Alternatively, a detector may also be used which is only responsive when, in addition, the total energy of both photons is within a specified bandwidth. Background radiation may also be effectively suppressed in each instance using these methods as well.

A further embodiment provides for a detector to be used which is only responsive when, in addition, the two photons enter at incidence into two different ones of the sensor elements. This prevents the detector from also being able to function in response to one single photon entering the detector at incidence.

A further embodiment provides for a detector to be used which is only responsive when, in addition, the two photons enter one and the same sensor element at incidence. In this manner, those photon pairs may be selected whose members exhibit a small spatial dispersion, i.e., a “narrow” photon pair.

A further embodiment provides for an imaging element, in particular a converging lens, to be used, which forms an image of the object or of a portion thereof on the interference field.

In a further embodiment, an aperture diaphragm is used which limits the angle of incidence at which photon packets coming from the object are able to enter the detector at incidence.

The intensity of the light used to illuminate the object and the intensity of the reference light are each selected to be so low that there is minimal impinging of the two photon packets on the detector within the time span window, for example less than 1% or, for example, less than 0.1%.

To permit visual observation of the hologram, it may be illuminated by photon packets that are each composed of a plurality of mutually quantum-mechanically correlated photons which, together, produce a multi-photon Fock state.

### BRIEF DESCRIPTION OF THE DRAWINGS

FIG. 1 shows an exemplary embodiment of the present invention for producing a hologram of an object, including a light source which generates two beams of photon packets, one of which is used to illuminate the object and the other to produce the reference light, and including a detector onto which the light coming from the object and the reference light impinge at different angles.

FIG. 2 shows an exemplary embodiment of the present invention, including a light source which generates three beams of photon pairs, of which two beams are used to illuminate the object and one beam is used to produce the reference light.

FIG. 3 shows an exemplary embodiment of the present invention, including the light source and the detector of FIG. 1, the light coming from the object and the reference light impinging coaxially on the detector.

FIG. 4 shows an exemplary detector which may be introduced into the arrangements of FIGS. 1 through 3.

FIG. 5 shows an exemplary detector which may be introduced into the arrangements of FIGS. 1 through 3.

FIG. 6 shows an exemplary detector which may be introduced into the arrangements of FIGS. 1 through 3.

### DETAILED DESCRIPTION

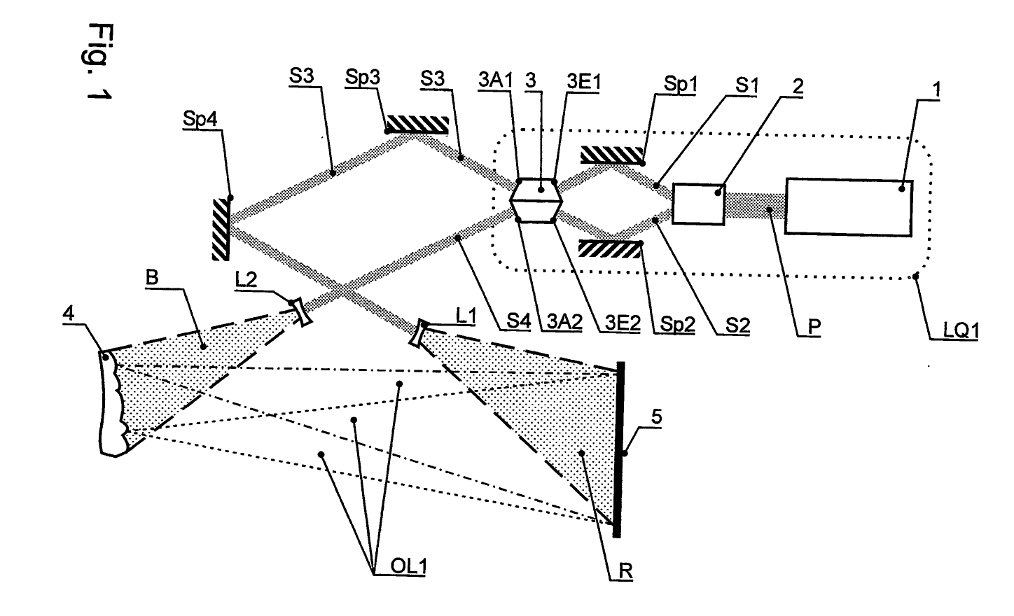

FIG. 1 shows an exemplary embodiment of the present invention for producing a hologram of an object 4, including a light source LQ1 which generates two beams S3, S4 of photon packets, one of which, namely beam S4, is used to illuminate object 4, and the other, namely beam S3, to produce the reference light, and including a detector onto which the light coming from the object and the reference light impinge at different angles.

Light OL1 coming from object 4 and reference light R interfere with one another in an interference field whose brightness distribution is recorded by a detector 5, onto which light OL1 coming from object 4 and reference light R impinge at different angles in the example of the arrangement of FIG. 1.

To produce a hologram of object 4 to illuminate object 4, as well as to produce reference light R, photon packets are used, each of which is composed of a plurality of mutually quantum-mechanically correlated photons which, together, produce a multi-photon Fock state. In the example of the arrangement of FIG. 1, as photon packets, photon pairs are used, each of which is composed of two mutually quantum-mechanically correlated photons which, together, produce a multi-photon Fock state.

For that reason, the arrangement of FIG. 1 includes a light source LQ1, which is capable of emitting two beams S3, S4 of such photon pairs, one of which is used in accordance with the present invention to produce illuminating beam B and the other to produce reference light R. Light source LQ1 includes the following components: a) a primary light source 1; b) an optically nonlinear crystal 2; c) an interferometer having two arms; and d) a beam coupler 3 having a first coupler input 3E1, a second coupler input 3E2, a first coupler output 3A1 and a second coupler output 3A2.

a) A laser 1, which emits a beam P of primary photons of mean wavelength λ, is used as a primary light source 1 in the arrangement of FIG. 1.

b) Optically nonlinear crystal 2 is so constituted, arranged and oriented that at least one portion of the primary photons enters crystal 2 at incidence and, as the result of optical parametric fluorescence, generates in the same one pair each of secondary photons emerging from crystal 2, namely one signal photon and one idler photon belonging to and quantum-mechanically correlated with the signal photon. This process is controlled in light source LQ1 so that the signal photons emerge in a beam S1 and the idler photons in a beam S2 from crystal 2, the two beams S1 and S2 exhibiting different directions; this may be accomplished by orienting crystal 2 accordingly. Beam S1 is coupled into the first and beam S2 into the second arm of the interferometer.

Optically nonlinear crystal 2 may be composed, for example, of beta-barium borate, potassium-deuterium phosphate or lithium niobate. The total energy of the photon pair corresponds to the energy of the primary photon. Therefore, the wavelength of each secondary photon is larger than that of the primary photon.

c) In the arrangement of FIG. 1, two deflecting mirrors Sp1, Sp2, as well as one optical delay element (not shown in FIG. 1) make up the interferometer. Deflecting mirror Sp1 is situated in the first arm of the interferometer and deflects beam S1 in such a way that the signal photons enter through first input 3E1 into beam coupler 3 at incidence. Deflecting mirror Sp2 is situated in the second arm of the interferometer and deflects beam S2 in such a way that the idler photons enter through second input 3E2 into beam coupler 3 at incidence. Thus, the two arms of the interferometer merge in beam coupler 3. The arms of the interferometer may be constituted of light guides.

The optical delay element (not shown) is interposably installed in one of the arms so as to permit a continuous adjustment of path-length difference D between the first and the second arm of the interferometer, path-length difference D being adjustable to be smaller than the coherence length of the signal photon, as well as smaller than the coherence length of the idler photon, and, also adjustable to value D=0. The delay element may be formed, for example, in that one of deflecting mirrors Sp1, Sp2 is adjustable in a direction perpendicular to its surface. In addition, the delay element may be constituted of an adjustable mirror system, which is optically interposed in one of the interferometer arms. In addition, the delay element may be constituted of an electrically controllable, double-refracting delay element which is optically interposed in one of the interferometer arms.

d) In beam coupler 3, the signal photons may interfere with their associated idler photons. Following this interference, each signal photon and each idler photon are able to exit beam coupler 3 both through first coupler output 3A1 and through second coupler output 3A2. Thus, after interfering with one another in this manner, the signal photon and its associated idler photon may exit beam coupler 3 either separately from one another through different coupler outputs 3A1, 3A2, or they may exit beam coupler 3, together, as a photon pair, whose members are mutually quantum-mechanically correlated and, together, are in a two-photon Fock state, in a so-called Hong-Ou-Mandel interference, through each of the two coupler outputs 3A1, 3A2, so that the light source is capable of emitting a first beam S3 of such photon pairs through first coupler output 3A1 and a second beam S4 of such photon pairs through second coupler output 3A2.

Thus, one beam of such photon pairs emerges from each of the two coupler outputs 3A1, 3A2. The beam coupler may be set up in such a way that, on average over time, the same number of photon pairs emerges through each of coupler outputs 3A1, 3A2, so that neither of coupler outputs 3A1, 3A2 is preferred. As beam coupler 3, a beam splitter, such as a beamsplitter plate may be used, for example.

Probability W that the signal photon and the idler photon exit beam coupler 3, together, through same coupler output 3A1 or 3A2, depends in a complex manner on optical path-length difference D. It is thus possible to maximize the yield of such photon pairs by choosing the path-length difference accordingly. The greatest possible yield of such photon pairs, namely theoretically 100%, and, thus, at the same time also the smallest proportion of those instances when the signal photon and its associated idler photon exit beam coupler 3 separately from one another through different coupler outputs 3A1, 3A2, namely theoretically 0%, are obtained for value D=0.

In accordance with the present invention, one portion of the thus produced photon pairs, namely in the example of the arrangement of FIG. 1, beam S4 is used to illuminate object 4. To this end, photon-pair beam S4 is widened by a diverging lens L2 to form an illuminating beam B which covers object 4. In response to illumination by illuminating beam B, photon pairs emanate from object 4 and reach detector 5 as object light OL1. If object 4 is small enough, or if it is only intended that a small enough part of object 4 be captured by the hologram, then there is no need for photon-pair beam S4 to be widened; rather, in such a case, beam S4 may be directly used as an illuminating beam.

In addition, one portion of the thus produced photon pairs, For example in the arrangement of FIG. 1, photon-pair beam S3, is used to form reference light R. To this end, photon-pair beam S3 is directed by additional deflecting mirrors Sp3, Sp4 in the direction of detector 5 and widened by a diverging lens L1 to form reference light R, i.e., reference light R is produced from beam S3 by widening the same.

Photon packets coming from object 4, such as object light OL1, which originate from illuminating beam B and thus from light source LQ1, interfere with reference light R in the interference field. Detector 5 records the brightness distribution in the interference field or in a part of the same as a hologram of object 4. To obtain a hologram having the greatest possible contrast, an embodiment (not shown) of the arrangement of FIG. 1 provides for reference light R to be attenuated by an attenuator before impinging on detector 5, so that reference light R and object light OL1 have substantially the same mean intensities in the interference field.

An embodiment of the present invention provides for a light source to be used that is set up in such a way that the object light and the reference light have the same amplitude, i.e., the same intensity in the interference field.

Beam coupler 3 replaces the beam splitter, which, under the related art, typically splits the coherent light required for producing a hologram into the illuminating beam and the reference beam, since, with the aid of beam coupler 3, light source LQ1 already emits two coherent component beams in the first place, of which one is able to be used to illuminate the object and the other as a reference beam or to form the same.

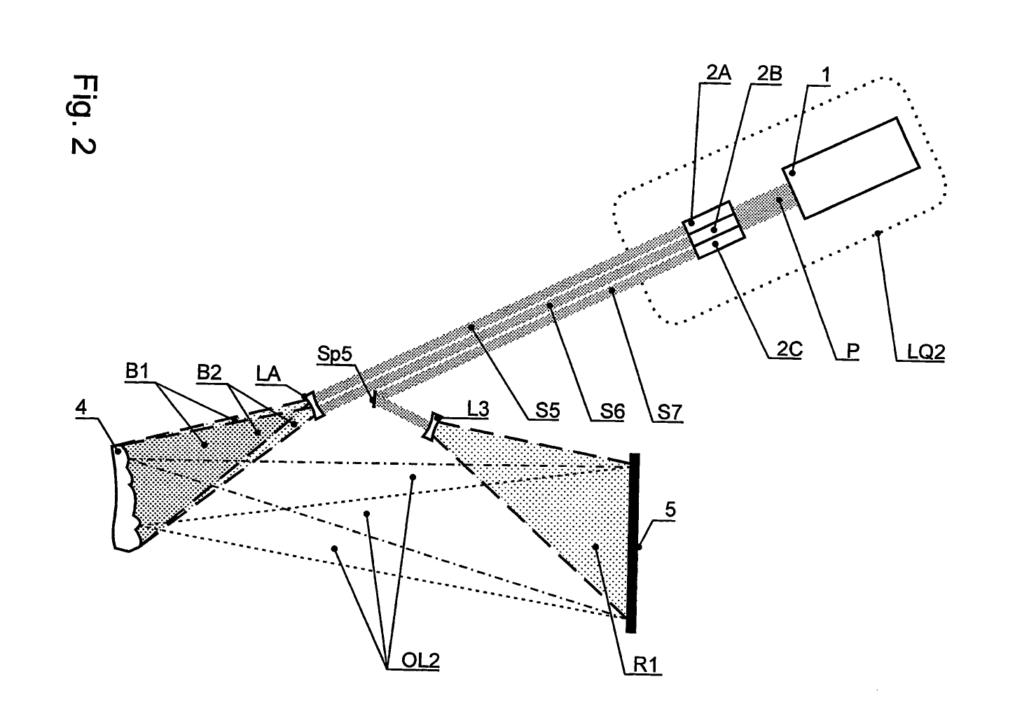

FIG. 2 shows an embodiment of the present invention, having a light source LQ2 which produces two illuminating beams B1, B2 for illuminating object 4 and a reference beam R1 as reference light. Light OL2 coming from object 4 and reference beam R1 interfere with one another in an interference field whose brightness distribution is recorded by detector 5.

The arrangement of FIG. 2 has a light source LQ2 which is capable of emitting three beams S5, S6, S7 of such photon pairs, each of which is composed of two mutually quantum-mechanically correlated photons which, together, produce a two-photon Fock state. Two of the beams of photon packets, namely S5 and S6, are used to illuminate the object, and the third of the beams of photon packets, namely beam S7, is used to produce reference light R1.

Light source LQ2 includes primary light source 1 of FIG. 1 and three optically nonlinear crystals 2A, 2B, 2C.

The optically nonlinear crystals 2A, 2B, 2C are so constituted, arranged, and oriented, in each case that a portion of the primary photons enters into each of the same at incidence, and, in each of crystals 2A, 2B, 2C, one of the photon-pair beams S5, S6, S7 of photon packets is formed from primary photons radiated into the same, as the result of optical parametric fluorescence. Each of the thus produced photon packets is composed of two secondary photons, namely one signal photon and one idler photon belonging to and quantum-mechanically correlated with the signal photon. This process is controlled in light source LQ2 in such a way that the signal photons and the idler photons emerge from crystals 2A, 2B, 2C substantially in parallel to one another in each case, i.e., each of photon-pair beams S5, S6, S7 contains both signal photons as well as idler photons. This may be achieved by orienting crystals 2A, 2B, 2C accordingly. Optically nonlinear crystals 2A, 2B, 2C may be composed, for example, of beta-barium borate, potassium-deuterium phosphate, or lithium niobate.

Thus, each photon pair is generated in one of three channels, it not being predictable in which one.

Crystals 2A, 2B, 2C may be spaced apart from one another in order that photon-pair beams S5, S6, S7 propagate in a spatially separate relation; this spaced apart relation of crystals 2A, 2B, 2C is not shown in FIG. 2. If the diameter of primary-photon beam P is too small to cover all crystals 2A, 2B, 2C, then it can be widened accordingly before reaching crystals 2A, 2B, 2C. Such a widening is not shown in FIG. 2. Crystals 2A, 2B, 2C may be designed, for example, as optically nonlinear waveguides.

In accordance with the present invention, one portion of the thus produced photon pairs, such as in the arrangement of FIG. 2, photon-pair beams S5 and S6, is used to illuminate object 4. To this end, photon-pair beams S5 and S6 are widened by a diverging lens array LA to form an illuminating beam B1 or B2, which, in the example of FIG. 2, each cover the entire object 4.

In addition, another portion of the photon pairs produced by light source LQ2, such as in the example of the arrangement of FIG. 2, beam S7, is used to form reference beam R1. To this end, photon-pair beam S7 is directed by a deflecting mirror Sp5 in the direction of detector 5 and widened by a diverging lens L3 to form reference light A1.

In response to illumination by illuminating beams B1, B2, photon pairs emanate from object 4, for example, due to reflection and scattering of illuminating beams B1, B2 at the surface of object 4, and continue on in the form of photon pairs to reach the interference field as light OL2 coming from the object and interfere there with reference beam R1. Detector 5 records the brightness distribution in the interference field or in a part of the same as a hologram of object 4.

The arrangement of FIG. 2 may provide that more photon packets are used in the first place to illuminate object 4 than to form reference beam R1. This increases the intensity of object light OL2 in comparison to that of reference beam R1, thereby eliminating the need in many cases for an attenuator to reduce the intensity of reference beam R1.

In a further embodiment of the present invention, the arrangement of FIG. 2 is modified in such a way that more than three photon-packet component beams are produced, of which one or a few are used to form the reference beam and the remaining ones to illuminate the object.

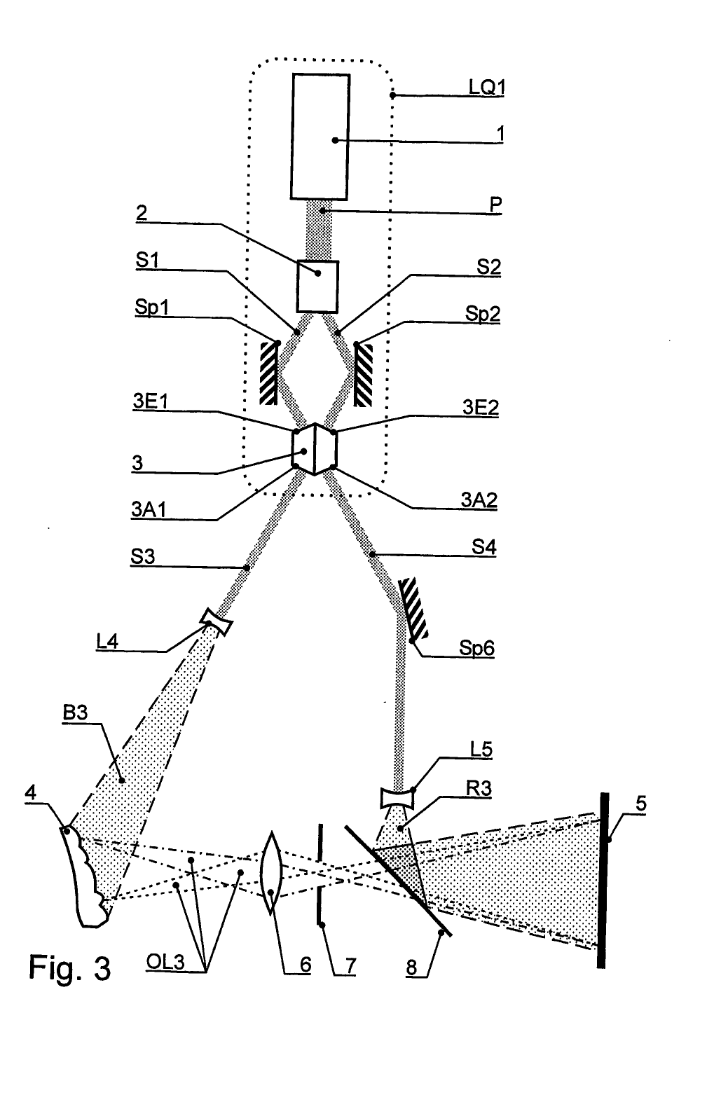

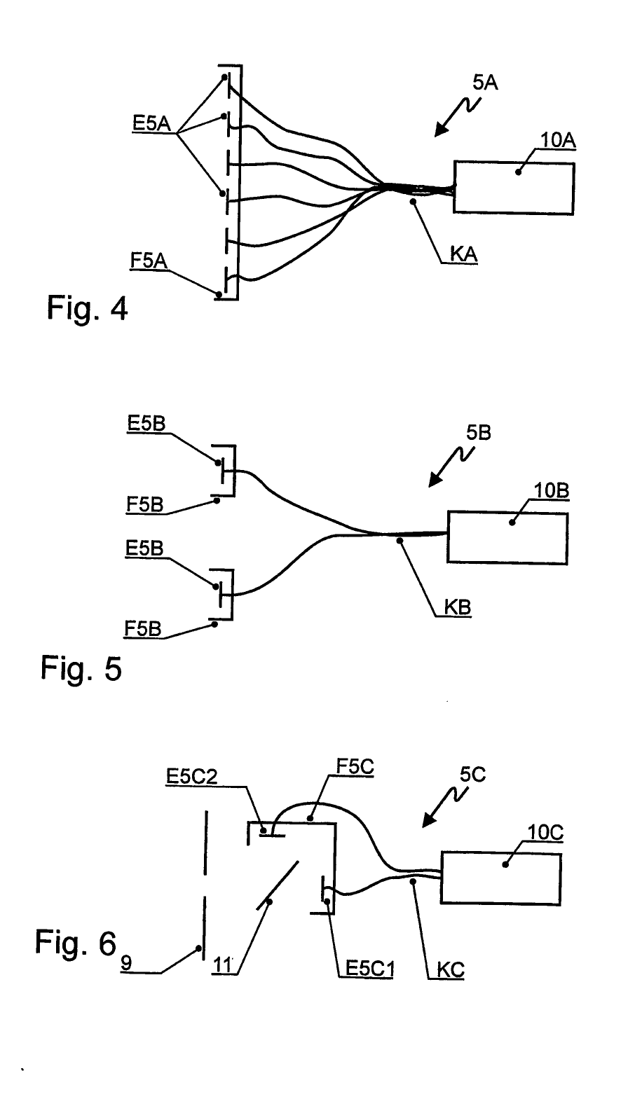

FIG. 3 shows another exemplary embodiment of an arrangement according to the present invention, including light source LQ1 and detector 5 of FIG. 1, light OL3 coming from object 4 and reference beam R3 impinging coaxially on detector 5.

The principle of operation of light source LQ1 has already been explained with reference to FIG. 1. Light source LQ1 emits two photon-pair beams S3, S4 which are not parallel to one another. Photon-pair beam S3 is widened by a lens L4 to form an illuminating beam B3, which covers the entire object 4. In response to this illumination, object light OL3 in the form of photon pairs coming from object 4 emanates from object 4 and reaches the interference field after passing through a converging lens 6 and an aperture diaphragm 7, as well as after propagating through a beamsplitter plate 8. Converging lens 6 is used to form an image of object 4 on detector 5. Aperture plate 7 is used to adapt the aperture angle at which the portion of object light OL3 passing through beamsplitter plate 8 is incident to detector 5, to the aperture angle at which the portion of reference light R3 reflected by the beamsplitter plate is incident to the detector.

Photon-pair beam S4 is directed by a deflecting mirror Sp6 at a beamsplitter plate 8. Disposed between deflecting mirror Sp6 and the beamsplitter plate is a diverging lens L5, which widens photon-packet beam S4 to form reference light R3, i.e., beam S4 is used to form reference light R3. Beamsplitter plate 8 reflects a portion of reference light R3 into the interference field, where this portion interferes with the portion of object light OL3 transmitted by beamsplitter plate 8.

The positions of object 4, of deflecting mirror Sp6 and of beamsplitter plate 8 are selected in this case in such a way that the portion of object light OL3 transmitted by beamsplitter plate 8, and the portion of reference light R3 reflected by the beamsplitter plate are coaxially incident to the interference field and detector 5. This signifies an adaptation of the angle of incidence of the photon pairs coming from object 4 and of reference light R3 to detector 5 and has an advantageous effect on the resolution of the hologram, for example. Detector 5 records the brightness distribution in the interference field or in a part of the same as a hologram of object 4.

The detector 5 may alternatively be oriented in such a way that the portion of object light OL3 reflected by beamsplitter plate 8 and the portion of reference light R3 transmitted by beamsplitter plate 8 are coaxially incident to detector 5. In this case, detector 5 is to be positioned underneath beamsplitter plate 8 in FIG. 3 (not shown).

Detector 5 in FIGS. 1 through 3 may be a photoplate, for example. In addition, detector 5 may be a CCD detector, for example. In this case, detector 5 includes an evaluation circuit (not shown in FIGS. 1 through 3).

FIG. 4 shows a schematic cross-sectional representation of a detector 5A which may be employed in the arrangements of FIG. 1 through 3 in place of detector 5 shown there. Detector 5A includes a multiplicity of light-sensitive sensor elements E5A, which are designed as individual CCD elements E5A and are arrayed as a two-dimensional matrix on a mount F5A. Thus, they form a two-dimensional CCD matrix, so that detector 5A is two-dimensionally resolving. Individual CCD elements E5A are connected via a cable set KA to an evaluation circuit 10A. Detector 5A may be set up to only respond when two photons, whose total energy is within a specified bandwidth, enter detector 5A at incidence within a specifiable time span window, so that, in essence, detector 5A is only responsive when one of the photon pairs enters detector 5A at incidence and not when one single photon enters the same at incidence, alone.

FIG. 5 shows a schematic cross-sectional representation of a detector 5B which may likewise be employed in the arrangements of FIG. 1 through 3 in place of detector 5 shown there. Detector 5B includes two light-sensitive sensor elements E5B, which are each designed as individual CCD elements E5B and are arrayed in a mount F5B and are capable of scanning the interference field dependently or independently of one another.

The two individual CCD elements E5B are connected via a cable set KB to an evaluation circuit 10B.

Detector 5B may be set up to only respond when one photon enters each of the two individual CCD elements E5B at incidence within a specifiable time span window, and when the total energy of these two photons is within a specified bandwidth, so that, in essence, detector 5B is also only responsive when one of the photon pairs enters detector 5B at incidence and not when one single photon enters the same at incidence, alone.

For example, detector 5B is not responsive to one single photon, whose energy is within the specified bandwidth, entering detector 5B at incidence. However, detector 5B is not responsive to those photon pairs whose members exhibit such a small mutual spacing that both photons of the photon pair enter the same individual CCD element at incidence. Thus, detector 5B only functions in response to “wide” photon pairs.

FIG. 6 shows a schematic cross-sectional representation of a detector 5C which may likewise be employed in the arrangements of FIGS. 1 through 3 in place of detector 5 shown there, and which is only responsive to “narrow” photon pairs. Detector 5C includes a detector beamsplitter 11 which is oriented to permit the photons coming from object 4 and photons of the reference beam to impinge in each case thereon, and is capable of transmitting a portion of these photons and of deflecting another portion thereof.

In addition, detector 5C includes two light-sensitive sensor elements E5C1, E5C2, such as a first individual CCD element E5C1 and a second individual CCD element E5C2, which are accommodated in a common mount F5C and are capable of scanning the interference field together, i.e., disposed in a constant mutual arrangement.

In this connection, first individual CCD element E5C1 is oriented to permit only those photons transmitted by the detector beamsplitter, to enter into the same at incidence. Second individual CCD element E5C2 is oriented to permit only those photons deflected by detector beamsplitter 11, to enter into the same at incidence. Thus, the two individual CCD elements E5C1, E5C2 are optically coupled to one another via beam splitter 11 and connected via a cable set KC to an evaluation circuit 10C.

Detector 5C is also set up to only respond when one photon enters each of the two individual CCD elements E5C1, E5C2 at incidence within a specifiable time span window, and when the total energy of these two photons is within a specified bandwidth, so that, in essence, detector 5C is also only responsive when one of the photon pairs enters detector 5C at incidence and not when one single photon enters the same at incidence, alone. For example, detector 5C is not responsive to one single photon, whose energy is within the specified bandwidth, entering detector 5C at incidence.

One drawback associated with detector 5C is that it is not responsive when both members of the photon pair are not separated at detector beamsplitter 11, but rather are both deflected or transmitted there. This reduces the efficiency of detector 5C by on average 50%.

Detector 5C functions in response to only those photon pairs which possess the property such that the projection of their mutual spacing onto detector 5C is smaller than a specific maximum value that is defined by the geometry of detector 5C; otherwise, for example, at least one of the members of the pair would not impinge on any of the individual CCD elements E5C1, E5C2. Thus, detector 5C only functions in response to “narrow” photon pairs. In this manner, those photon pairs may be selected whose members exhibit a small spatial dispersion, without the entry of one single photon at incidence being able to simulate the entry of a photon pair at incidence. The mentioned maximum value is further reduced in the example of FIG. 6 by an aperture diaphragm 9 positioned optically upstream of detector 5C.

In further embodiments, as a light source to produce holograms, one is used which produces quantum-mechanically correlated photon pairs, as described, for example, in the reference J. Brendel, “Quantenphänomene in der Welt des Lichtes” [“Quantum Phenomena in the World of Light”], chapter 4.1, Frankfurt am Main, 1994. Other photon pair sources, such as atom cascade sources, may also be used in accordance with the present invention when they produce correlated photon pairs. The resolution may be further enhanced by using photon packets containing more than two correlated photons in each instance. However, the sources available in the related art for photon packets having more than two correlated photons in each instance, are very weak, so that a substantial outlay of time is required to produce a hologram using such sources.

The members of the photon pairs may be conditioned at a beam splitter to form a pair that is capable of interfering, or a coherent pair, and subsequently fed into an available holographic structure. Light which originates from a laser, for example, also termed pump laser, impinges on a nonlinear optical crystal; a portion of the incident photons impinging in this manner, also termed pump photons, decays in the crystal in each instance into one signal photon and one idler photon, each on average of half the energy and twice the wavelength. In this context, the law of energy conservation holds, i.e., the sum of the signal photon and idler photon is equal to the energy of the incident pump photon. This process is called “parametric fluorescence.” The two photons created, signal photon and idler photon, impinge on the two input ports of a 50:50 beam splitter and exit the same as a pair, through one of the two output ports. For this purpose, the optical path difference between the signal photon and the idler photon must be selected in such a way that, for cases when:

a) both photons are reflected at the beam splitter or
b) both photons are transmitted by the beam splitter, the paths of the photons are indistinguishable. See, e.g., reference C.K. Hong et al., “Measurement of Subpicosecond Time Intervals between Two Photons by Interference”, Phys. Rev. Letters, vol. 59, page 2044 (1987).

The two output ports of the beam splitter, through which the photon pairs may exit the beam splitter, it not being established through which of the two output ports, are the input ports of the interferometer which produces the hologram. This means that the one output port produces the illuminating beam for the object, and the other the reference beam or the reference light. There are a variety of possible holographic arrangements. In the arrangement of FIG. 1, the two beams are transformed into spherical waves, the one illuminating the object and then, scattered by the object, being superposed with the reference spherical wave.

The superposition region is the interference field, which, recorded photographically or using a different type of detector, produces the hologram. Further possible holographic arrangements are described, for example, in the article “Holography” by L. Huff in the reference M. Bass, “Handbook of Optics”, vol. II, pages 23.1 et seq., New York, 1995; and the reference T. Kreis “Holographic Interferometry”, Berlin 1996.

In place of a photographic plate, electronic recording devices may be used as detectors. In this case, to permit visual observation of the hologram, it must be displayed on a suitable display, for example, on a liquid crystal display. The detectors used must detect individual photons or photon pairs. Sensitive video cameras, also in conjunction with light amplifiers, may record the hologram directly. With coincidence detection, recording only takes place when two image points respond simultaneously. Cameras which only record photon pairs at one image point are likewise suited (compare, for example, FIG. 4).

Detector pairs are able to scan the interference field independently of one another and thus record the hologram (compare, for example, FIG. 5). If the detector pairs are connected in coincidence, then only photon pairs are recorded. Also possible are detector pairs which are coupled together via a beam splitter and which scan the interference field together, in coincidence. Detectors of this kind are also described in the above-identified J. Brendal reference.

The recording of holograms by video cameras is often made difficult by the insufficient resolution of the camera. However, the structures of the hologram become coarser and, therefore, are more easily recorded when the reference beam and the object beam (or reference light and object light) propagate coaxially (compare FIG. 3).

The present invention has industrial applicability, for example, in the fields of reproduction technology, holographic monitoring of the shapes of mass-produced components, photolithography used in producing semiconductor components, and holographic storing of information.

1-59. (canceled)

60. A method for producing a hologram of an object, in which photon packets are used to illuminate the object and as reference light, each of the photon packets is composed of a plurality of mutually quantum-mechanically correlated photons which, together, produce a multiphoton Fock state,
one portion of the photon packets being used for illuminating the object and one portion of the photon packets being used as reference light;
the photon packets coming from the object being made to interfere with the reference light in an interference field; and
and the brightness distribution in the interference field or in a part of the same being recorded by a detector.

61. The method as recited in claim 60,
wherein a light source capable of emitting a coherent beam of such photon packets is used to generate the photon packets.

62. The method as recited in claim 60, wherein a light source capable of emitting a plurality of mutually coherent beams of such photon packets is used to produce the photon packets.

63. The method as recited in claim 62, wherein at least one of the beams of photon packets is used to illuminate the object and at least one other one of the beams of photon packets is used as reference light or to form the same.

64. The method as recited in claim 61, wherein, as a light source, one is used which, as photon packets, produces photon pairs whose two members are mutually quantum-mechanically correlated; and together, are in a two-photon Fock state.

65. The method as recited in claim 61, wherein, as a light source, one is used in which the photon packets are generated in that primary photons of mean wavelength λ are radiated from a primary light source, in particular a laser, into an optically nonlinear crystal, which is so constituted and oriented that the photon packets are formed in the optically nonlinear crystal from primary photons radiated into the same, as the result of optical parametric fluorescence.

66. The method as recited in claim 62, wherein, as a light source, one is used which has the following components:
a) a primary light source, in particular a laser, which emits a beam of primary photons of mean wavelength λ;
b) an optically nonlinear crystal, which is so constituted, arranged and oriented that at least one portion of the primary photons is incident to the crystal and, as the result of optical parametric fluorescence, generates in the same one pair each of secondary photons emerging from the crystal, namely one signal photon and one idler photon belonging to and quantum-mechanically correlated with the signal photon;
c) an interferometer having two arms between which an optical path-length difference exists that is both smaller than the coherence length of the signal photon, as well as smaller than the coherence length of the idler photon, at least one portion of the pairs of secondary photons entering the interferometer at incidence in such a way that the signal photon propagates through the first arm and the associated idler photon through the second arm;
d) a beam coupler having a first and a second coupler output;
it being possible for the signal photons and the associated idler photons to enter the beam coupler at incidence after propagating through the interferometer;
the signal photon of each pair of secondary photons which entered the beam coupler at incidence being able to interfere with its associated idler photon in the beam coupler;
following this interference, each signal photon and each idler photon being able to exit the beam coupler both through the first and through the second coupler output; so that the signal photon and its associated idler photon are able to exit the beam coupler either separately from one another through different coupler outputs, or, together, as a photon pair whose members are mutually quantum-mechanically correlated and, together, are in a two-photon Fock state, through each of the two coupler outputs; and, thus, a first beam of such photon pairs exits through the first coupler output, and a second beam of such photon pairs exits through the second coupler output, two beams of such photon pairs being thereby produced.

67. The method as recited in claim 66, wherein the first beam of photon pairs is used to illuminate the object; and the second beam of photon pairs is used as reference light or to form the same; or vice versa.

68. The method as recited in claim 66, wherein the amount of the optical path-length difference existing between the first and the second arm of the interferometer is selected to be less than 5λ, λ being the mean wavelength of the primary photons.

69. The method as recited in claim 66, wherein the level of efficiency achieved in generating the photon pairs is optimized in that the optical path-length difference existing between the first and the second arm of the interferometer is selected in such a way that the ratio
of the number of instances when the signal photon and its associated idler photon exit the beam coupler together through the same coupler output,
to the number of instances when the signal photon and its associated idler photon exit the beam coupler separately from one another, through different coupler outputs, reaches a time-averaged maximum.

70. The method as recited in claim 64, wherein, as a light source, one is used in which the photon pairs are produced by quadrupole transitions or cascade transitions occurring in the light source.

71. The method as recited in claim 64, wherein, as a light source, one is used in which the photon pairs are produced by a two-photon laser.

72. The method as recited in claim 64, wherein, as a light source, one is used in which the photon pairs are produced by a Coulomb blockade effect occurring in the light source.

73. The method as recited in claim 61, wherein the beam of photon packets is split into a plurality of mutually coherent photon-packet component beams, or a plurality of mutually coherent photon-packet component beams is extracted from the beam of photon packets, at least one of the photon-packet component beams being used to illuminate the object (4) and at least one other of the photon-packet component beams being used as reference light or to form the same.

74. The method as recited in claim 62, wherein, as a light source, one is used which generates a plurality of beams of photon packets, in that primary photons of mean wavelength λ are radiated from a primary light source, in particular a laser, into a plurality of optically nonlinear crystals, the crystals being so constituted, arranged and oriented that, in each of the crystals, one of the beams of photon packets is formed from primary photons radiated into the same, as the result of optical parametric fluorescence.

75. The method as recited in claim 74, wherein, as an optically nonlinear crystal or as optically nonlinear crystals, those are used which are composed of beta-barium borate, of potassium-deuterium phosphate or of lithium niobate.

76. The method as recited in claim 74, wherein, as an optically nonlinear crystal or as optically nonlinear crystals, those are used which are designed as optical waveguides.

77. The method as recited in claim 74, wherein the number of photon-packet component beams or of beams of photon packets which are used to illuminate the object is greater than the number of photon-packet component beams or of beams of photon packets which are used as reference light.

78. The method as recited in claim 74, wherein, as a primary light source, one is used which emits a beam of primary photons of mean wavelength λ,
the beam of primary photons being split into a plurality of mutually coherent component beams of primary photons;
or a plurality of mutually coherent component beams of primary photons being extracted from the beam of primary photons;
and each of the thus produced component beams of primary photons being radiated into one of the optically nonlinear crystals.

79. The method as recited in claim 78, wherein the beam of photon packets or the beam of primary photons is split by at least one obstacle introduced into the same, or by a stop having a plurality of pinholes, introduced into the same, or by at least one beam splitter introduced into the same, into a plurality of photon-packet component beams or a plurality of component beams of primary photons.

80. The method as recited in claim 78, wherein the beam of photon packets or the beam of primary photons is split by a phase plate introduced into the same, into a plurality of at least partially mutually phase-shifted, photon-packet component beams or component beams of primary photons.

81. The method as recited in claim 80, wherein, as a phase plate, one is used which splits the beam of photon packets into two photon-packet component beams, between which a phase difference of (2n+1)*π/Z exists, n being a whole number and Z the number of photons per photon packet.

82. The method as recited in claim 80, wherein, as a phase plate, a zone plate having a first and a second zone group is used, whose design is such that
a photon-packet component beam emanates from every zone of the first zone group, so that, emanating from the zone plate is a first group of photon-packet component beams whose characteristic is such that every photon-packet component beam of this first group has propagated through one of the zones of the first zone group;
a photon-packet component beam emanates from every zone of the second zone group, so that, emanating from the zone plate is a second group of photon-packet component beams whose characteristic is such that every photon-packet component beam of this second group has propagated through one zone of the second zone group;
and the photon-packet component beams of the first group exhibit a phase difference of (2m+1)*π/Z compared to those of the second group, m being a whole number and Z the number of secondary photons per photon packet.

83. The method as recited in claim 78, wherein, to extract a plurality of photon-packet component beams from the beam of photon packets, or to extract a plurality of component beams of primary photons from the beam of primary photons, one optical waveguide is used in each case, which is introduced into the beam of photon packets in such a way that a portion of the beam of photon packets and, respectively, a portion of the beam of primary photons are coupled into each optical waveguide.

84. The method as recited in claim 74, wherein, as a primary light source, one is used which emits a plurality of beams of primary photons, each of mean wavelength λ, each of which is radiated into one of the optically nonlinear crystals in such a way that, in each of the crystals, one of the beams of photon packets is formed from one of the radiated beams of primary photons as the result of optical parametric fluorescence.

85. The method as recited in claim 84, wherein, as a primary light source, a laser is used in which a transverse mode or a spiral mode is generated, which lead to the formation of at least two discrete brightness zones in the laser, each one of which emits one of the beams of primary photons.

86. The method as recited in claim 84, wherein, as a primary light source, a kaleidoscope laser is used, in which a plurality of discrete brightness zones form, each one of which emits one of the beams of primary photons.

87. The method as recited in claim 61, wherein at least two of the beams of photon packets are used for illuminating the object and, prior to reaching the same, are widened into illuminating beams in such a way that each illuminating beam completely covers the object.

88. The method as recited in claim 61, wherein at least two of the beams of photon packets are used for illuminating the object and, prior to reaching the same, are widened into illuminating beams in such a way that each illuminating beam only covers a portion of the object, and all illuminating beams, together, cover the entire object.

89. The method as recited in claim 61, wherein at least two of the beams of photon packets are used to produce the reference light in that, before reaching the detector, they are each widened into reference beams in such a way that the reference beams all overlap in a region that takes up at least 90% of the interference field.

90. The method as recited in claim 61, wherein at least two of the beams of photon packets are used to produce the reference light in that, before reaching the detector, they are each widened into reference beams in such a way that each of the reference beams overlaps with one or more of the other reference beams in a region that takes up, at most, 10% of the interference field.

91. The method as recited in claim 60, wherein, to record the interference field, a two-dimensionally resolving detector, in particular a video camera, is used.

92. The method as recited in claim 91, wherein, as detector, one is used which includes a two-dimensional array of a multiplicity of light-sensitive sensor elements.

93. The method as recited in claim 60, wherein, as detector, one is used which includes a light-sensitive sensor element capable of scanning the interference field.

94. The method as recited in claim 60, wherein, as detector, one is used which includes two light-sensitive sensor elements which are capable of scanning the interference field dependently or independently of one another.

95. The method as recited in claim 60, wherein, as detector, one is used which includes the following components:
(a) a detector beamsplitter which is oriented to permit the photons coming from the object and the photons of the reference beam to impinge in each instance on the detector beamsplitter, and is capable of transmitting a portion of these photons and of deflecting another portion of these photons;
(b) a first light-sensitive sensor element oriented to permit only those photons transmitted by the detector beamsplitter, to enter into the same at incidence;
(c) a second light-sensitive sensor element oriented to permit only those photons deflected by the detector beamsplitter, to enter into the same at incidence and is capable of scanning the interference field.

96. The method as recited in claim 60, wherein the detector is one of: i) capable of functioning in response to individual photons entering the detector at incidence, and ii) only responsive to one of the photon packets entering the detector at incidence, and not to one single photon entering the same at incidence, alone.

97. The method as recited in claim 60, wherein the detector only functions in response to two photons, whose energy is greater in each instance than a specified low threshold value, entering the detector at incidence within a specifiable time span window.

98. The method as recited in claim 97, wherein the detector is only responsive when, in addition, the energy of both photons is less in each instance than a specified, first upper threshold value.

99. The method as recited in claim 97, wherein the detector is one of: i) only responsive when, in addition, the total energy of both photons is less than a specified, second upper threshold value, and ii) only responsive when, in addition, the total energy of both photons is within a specified bandwidth.

100. The method as recited in claim 97, wherein the detector is only responsive when, in addition, the two photons enter at incidence into two different ones of the sensor elements.

101. The method as recited in claim 97, wherein the detector is only responsive when, in addition, the two photons enter at incidence into one and the same sensor element.

102. The method as recited in claim 60, wherein one of an imaging element and a converging lens, is used which forms an image of at least a portion of the object on the interference field.

103. The method as recited in claim 60, wherein an aperture diaphragm is used which limits the angle of incidence at which photon packets coming from the object are able to enter the detector at incidence.

104. The method as recited in claim 60, further comprising illuminating the hologram by at least one photon packet to permit visual observation of the hologram, wherein each of the at least one photon packet is composed of a plurality of mutually quantum-mechanically correlated photons which together produce a multi-photon Fock state.

105. An arrangement for producing a hologram of an object, including a light source capable of emitting photon packets, each of which is composed of a plurality of mutually quantum-mechanically correlated photons which, together, produce a multiphoton Fock state, one portion of the photon packets emitted by the light source being capable of illuminating the object and one portion of these photon packets being capable of functioning as reference light; the photon packets coming from the object being capable of interfering with the reference light in an interference field; and the brightness distribution in the interference field or in a part of the same being recordable by a detector.

106. The arrangement as recited in claim 105, wherein the light source is capable of emitting a coherent beam of such photon packets.

107. The arrangement as recited in claim 105, wherein the light source is capable of emitting a plurality of mutually coherent beams of such photon packets.

108. The arrangement as recited in claim 107, wherein at least one of the beams of photon packets is capable of illuminating the object and at least one other one of the beams of photon packets is capable of functioning as the reference light or of forming the same.

109. The arrangement as recited in claim 106, wherein the light source is one which, as photon packets, produces photon pairs whose two members are mutually quantum-mechanically correlated and, together, are in a two-photon Fock state.

110. The arrangement as recited in claim 106, wherein the light source has a primary light source and an optically nonlinear crystal, the primary light source radiating primary photons of mean wavelength λ into the crystal which is so constituted and oriented that it produces the photon packets from primary photons radiated into the same, as the result of optical parametric fluorescence.

111. The arrangement as recited in claim 109, wherein the light source includes:
a) a primary light source which emits a beam of primary photons of mean wavelength λ;
b) an optically nonlinear crystal, which is so constituted and arranged that at least one portion of the primary photons is incident to the crystal and, as the result of optical parametric fluorescence, generates in the same one pair each of secondary photons emerging from the crystal, namely one signal photon and one idler photon belonging to and quantum-mechanically correlated with the signal photon;
c) an interferometer having two arms between which an optical path-length difference exists that is both smaller than the coherence length of the signal photon as well as smaller than the coherence length of the idler photon, at least one portion of the pairs of secondary photons entering the interferometer at incidence in such a way that the signal photon propagates through the first arm and the associated idler photon through the second arm in each instance;
d) a beam coupler having a first and a second coupler output; it being possible for the signal photons and the associated idler photons to enter the beam coupler at incidence after propagating through the interferometer; the signal photon of each pair of secondary photons which entered the beam coupler at incidence being able to interfere with its associated idler photon in the beam coupler; following this interference, each signal photon and each idler photon being able to exit the beam coupler both through the first and through the second coupler output; so that the signal photon and its associated idler photon are able to exit the beam coupler either separately from one another through different coupler outputs; or, together, as a photon pair whose members are mutually quantum-mechanically correlated and, together, are in a two-photon Fock state, through each of the two coupler outputs; and, thus, the light source is capable of emitting a first beam through the first coupler output and a second beam of such photon pairs through the second coupler output.

112. The arrangement as recited in claim 111, wherein the first beam of photon pairs is capable of illuminating the object; and the second beam of photon pairs is capable of one of: functioning as reference light, forming the same, or vice versa.

113. The arrangement as recited in claim 111, wherein the amount of the optical path-length difference existing between the first and the second arm of the interferometer is less than 5λ, λ being the mean wavelength of the primary photons.

114. The arrangement as recited in claim 111, wherein the optical path-length difference existing between the first and the second arm of the interferometer is selected in such a way that the ratio of the number of instances when the signal photon and its associated idler photon exit the beam coupler together through the same coupler output, to the number of instances when the signal photon and its associated idler photon exit the beam coupler separately from one another, through different coupler outputs; exhibits a time-averaged maximum.

115. The arrangement as recited in claim 107, wherein the light source has a primary light source, as well as a plurality of optically nonlinear crystals, the primary light source radiating primary photons of mean wavelength λ into each of the crystals, and the crystals being so constituted and oriented that, in each of the crystals, one of the beams of photon packets is formed from primary photons radiated into the same, as the result of optical parametric fluorescence.

116. The arrangement as recited in claim 115, wherein the primary light source is capable of emitting a plurality of beams of primary photons, each of mean wavelength λ, and of radiating them into one each of the optically nonlinear crystals in such a way that, in each of the crystals, one of the beams of photon packets is formed from one of the beams of primary photons radiated into the same, as the result of optical parametric fluorescence.

117. The arrangement as recited in claim 115, wherein the optically nonlinear crystal are composed of one of: beta-barium borate, potassium-deuterium phosphate, and lithium niobate.

118. The arrangement as recited in claim 115, wherein the optically nonlinear crystal is designed as an optical waveguide.
